(19) United States
(12) Patent Application Publication
(10) Pub. No.: US 2007/0124120 A1
(43) Pub. Date: May 31, 2007

(54) CAD device, method of setting assembly definition and program for setting assembly definition for component manufactured by CAD device

(75) Inventor: Kazuhiko Hamazoe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/363,159

(22) Filed: Feb. 28, 2006

(30) Foreign Application Priority Data
Nov. 30, 2005 (JP) 2005-346811

(51) Int. Cl. G06F 17/50

(52) U.S. Cl. 703/1

(57) ABSTRACT

It is an object of the present invention to reduce setting errors of the degrees of freedom in an assembly definition of a component manufactured by a CAD device. In an assembly definition database, a plurality of assembly definition data is registered in advance, each of which includes a name of assembly definition, a definition order, a shape of the definition part, data expressing the degrees of freedom and the like. A determination unit in the CAD device compares shape data of the definition part in the assembly definition data selected by an operator with shape data of the specified set-up part of a component, and determines whether or not they match each other. When the above shape data matches, the degrees of freedom in the assembly definition data is set as the degrees of freedom of the specified part of the component.

### BACKGROUND OF THE INVENTION

1. Field of the Invention

The present invention relates to a CAD device having a function of setting an assembly definition for a component, a method of setting the assembly definition and program for setting the assembly definition for the component.

2. Description of the Related Art

A dimensional tolerance of a product is set by calculating a value of the square root of the sum of the squares or the like of tolerances of respective components, or by referring to tolerances of similar products. Alternatively, the tolerance is set based on past experience.

However, in the above manners, it is impossible to set the dimensional tolerance taking a three-dimensional shape of a component into consideration, and it is highly probable that incorrect calculation will occur in a high density product design. As a result of this, a problem is caused, in which an allowable error of an assembled product is not satisfied, or in which components can not be assembled as a product because of the accumulated error of the components, or the like. In the case as above, the design has to be conducted again.

A tolerance analysis system using three-dimensional CAD data has been realized for solving the above problems.

FIG. 1 is a flowchart of a conventional process for determining whether the degrees of freedom of an assembly definition is too high or too low.

First, an operator sequentially selects elements (shapes) in a three-dimensional CAD model (S11 of FIG. 1). The system assigns assembly definitions to the components selected by the operator (S12). Next, the operator sets the degrees of freedom in the assembly definition taking the design rationale into consideration (S13).

Next, the system calculates the degrees of freedom (S14), and determines whether or not the degree of freedom is too low (S15).

When it is determined that the set degrees of freedom is too low or too high in the step S15, the operator again starts to set the degrees of freedom in a step S16 and the process returns to the step S11 in which the operator again selects the elements. And, the assembly definitions are added/deleted as necessary.

When it is determined that the degrees of freedom is neither too high nor too low in the step S15, the setting of the degrees of freedom in the assembly definition is terminated.

As methods for determining a tolerance of a product, techniques as below are known.

In the Patent Document 1, an automatic tolerance determination device is disclosed in which a tolerance is automatically determined based on the dimensional tolerance specified by the JIS or the like and geometric shape, dimensions of a component and relationships of mounting fit and surface mounting among components which are input via an input device.

In the patent document 2, a tolerance distribution method is described in which a first related cross-part at which the cost for attaining variable tolerances for related assembly data can not be reduced very much and a second related cross-part at which the cost for attaining the variable tolerances for the related assembly data starts to increase substantially, are defined and the total tolerance is distributed to the respective variable tolerances by causing the variable tolerance to satisfy a first prescribed relationship to a total tolerance and also by causing the variable tolerance to satisfy a second prescribed relationship.

The above conventional tolerance analysis systems exhibit the problems below.

(1) It is necessary to set an assembly definition between components for each component in order to define how to convey variations among components due to dimensional tolerances of the respective components.

(2) When an assembly definition is set for a component, it is common to define degrees of freedom in six dimensions (six directions), however, only an expert can set the degrees of freedom because the manner of defining the six-dimensional degrees of freedom greatly influences the analysis result of the tolerance.

(3) When the setting of the degrees of freedom is not based on a design rationale, the analysis result by the tolerance analysis system does not satisfy a design specification of the product.

(4) In the tolerance analysis system, it is necessary to set the degrees of freedom such that none of the degree of freedom among components is too low or too high, and in a product consisting of a large number of components, it is difficult for an operator to set the degrees of freedom such that none of the degrees of freedom is too low or too high.

Patent Document 1

Japanese Examined Patent Application Publication No. 4-59666

Patent Document 2

Japanese Patent Application Publication No. 6-223081

### SUMMARY OF THE INVENTION

It is an object of the present invention to reduce setting errors of the degrees of freedom in an assembly definition of a component manufactured by a CAD device.

The CAD device according to the present invention comprises an assembly definition database in which a plurality of assembly definition data including attribute information of a set-up definition part of a component and data defining the degrees of freedom of a component is registered, a determination unit for determining, when particular assembly definition data registered in the assembly definition database is selected and a set-up part of a component of which an assembly definition is to be set is specified, whether or not the attribute information in the selected assembly definition data and attribute information in the CAD data of the specified part of the component conform to each other, and an assembly definition setting unit for setting the degrees of freedom in the assembly definition of the component based on the data defining the degrees of freedom in the assembly definition data when it is determined by the determination unit that the attribute information in the CAD data and the attribute information in the assembly definition data conform to each other.

According to the present invention, the degrees of freedom in an assembly definition of a component can be set independently of the level of expertise of an operator. Accordingly, it is possible to reduce setting errors of the degrees of freedom set by an operator and to improve the accuracy of setting an assembly definition.

The CAD device according to the present invention comprises a tolerance analysis unit for calculating an cumulative value of tolerances of respective components based on assembly definitions of respective components set by the assembly definition setting unit, and for analyzing whether or not the calculated cumulative value of tolerances satisfies a tolerance required by a product.

Thereby, it is possible to set the degrees of freedom in an assembly definition of a component independently of the level of expertise of an operator. Accordingly, it is possible to analyze the cumulative tolerance of a product made by assembling a plurality of components.

The CAD device according to the present invention comprises a warning unit for displaying warning information indicating that the specified set-up part of the component is not appropriate when it is determined by the determination unit that the attribute information in the assembly definition data and the attribute information in the CAD data do not conform to each other.

Thereby, a warning is displayed when the specification of the set-up part of the component involves an error, accordingly, the operator changes the parts specified and can efficiently set the assembly definition of the component.

The CAD device according to the present invention comprises a registration unit for registering the assembly definition data in the assembly definition database.

Thereby, the operator himself/herself can register the assembly definition of an arbitrary assembly shape.

The CAD device according to the present invention comprises the data defining the degrees of freedom in the assembly definition data, which includes data defining the degrees of freedom in directions of coordinate axes and the degrees of freedom in directions of rotation about the coordinate axes in the CAD data.

Thereby, it is possible to easily and accurately set the degrees of freedom in the directions of the coordinate axes and of the rotation about the coordinate axes of the component in the CAD data.

The CAD device according to the present invention comprises the assembly definition data, which includes data expressing a definition order of an assembly definition of the component, shape information of a set-up definition part and data defining the degrees of freedom in directions of coordinate axes and the degrees of freedom in directions of rotation about the coordinate axes, and the determination unit determines whether or not the shape information of the definition part and the shape information in the CAD data of the specified part conform to each other based on the data expressing the definition order.

Thereby, it is possible to determine whether or not the set-up part of a component is specified in accordance with the definition order in the assembly definition data, accordingly, it is possible to set the degrees of freedom such that the design rationale of a product is satisfied.

The CAD device according to the present invention comprises the data defining the degrees of freedom in the assembly definition data of a component, which is data expressing whether or not dimensional or angular variation of the component causes dimensional or angular influence of a product made by assembling the components.

Thereby, the degrees of freedom of a component are automatically set based on the degrees of freedom in the assembly definition data, and accordingly, it is possible to accurately calculate a dimensional or angular tolerance of an entire product made by assembling the components.

The CAD device according to the present invention comprises the data defining the degrees of freedom in the assembly definition data, which includes data expressing whether or not dimensional variations in the directions of an X, Y or Z axis of the component influences dimensions of a product made by assembling the components and data expressing whether or not variations in angles of rotational directions about the X, Y or Z axis of the component causes angular influence of a product made by assembling the components.

### BRIEF DESCRIPTION OF THE DRAWINGS

FIG. 1 is a flowchart of an analysis process;

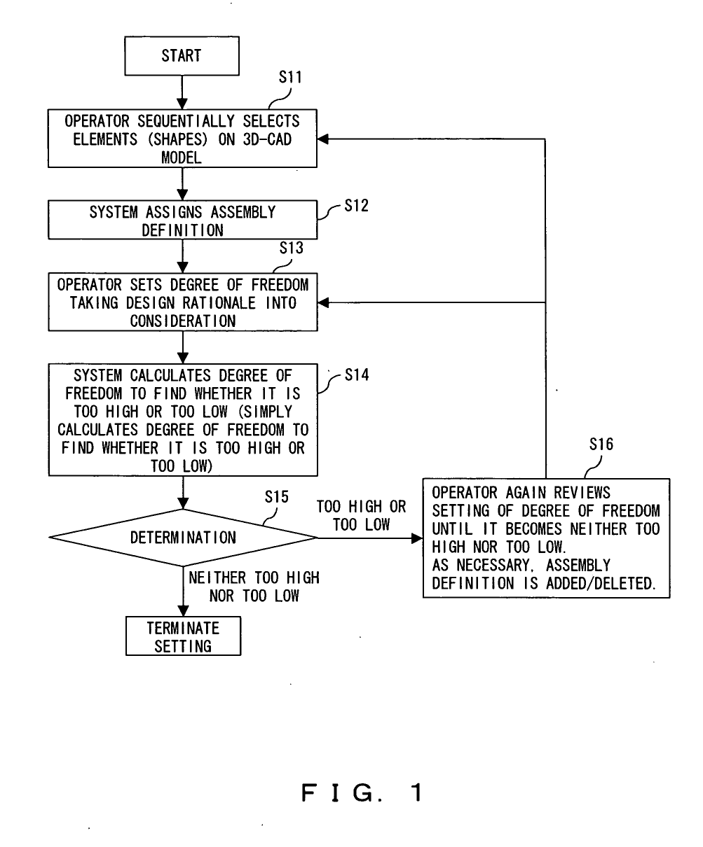

FIG. 2 shows a configuration of a CAD device according to the embodiment;

FIG. 3 is a block diagram of the CAD according to the embodiment;

FIG. 4 show a configuration of assembly definition data in an assembly definition database;

FIG. 5 explains the degrees of freedom of a component;

FIG. 6 shows an example of displaying the assembly definitions;

FIG. 7 is a flowchart of an assembly definition setting process according to the embodiment;

FIG. 8 explains a setting method of the assembly definition;

FIG. 9 explains definition order;

FIG. 10 explains a definition order 1;

FIG. 11 explains a definition order 2;

FIG. 12 explains a definition order 3;

FIG. 13 explains a definition order 4;

FIG. 14 shows CAD data of the component; and

FIG. 15 explains a determination of the assembly definition.

### DESCRIPTION OF THE PREFERRED EMBODIMENT

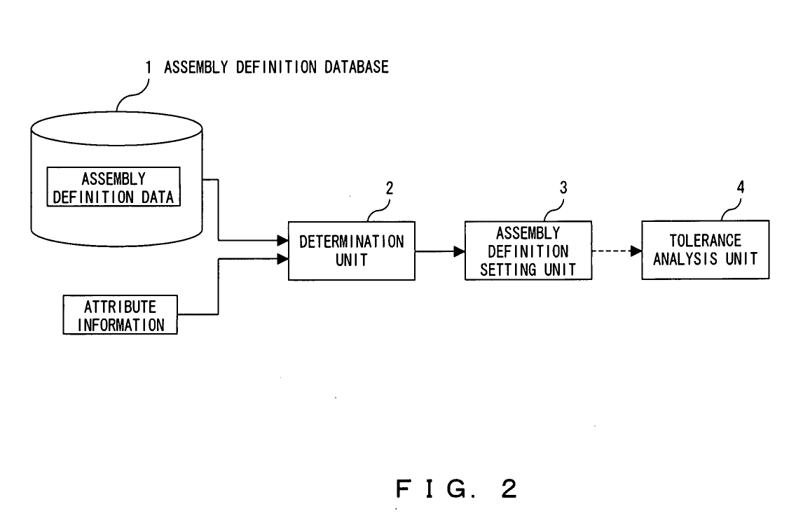

Hereinafter, embodiments of the present invention will be explained by referring to the drawings. FIG. 2 shows a preferred embodiment of the present invention.

The CAD device according to the present invention comprises an assembly definition database 1 in which a plurality of assembly definition data including attribute information of a set-up definition part in a component and data defining the degrees of freedom of the component are registered, a determination unit 2 for determining, when a particular assembly definition data registered in the assembly definition database 1 is selected and a set-up part in a component about which the assembly definition is to be set is specified, whether or not the attribute information in the selected assembly definition data and attribute information in CAD data of the specified part in the component about which the assembly definition is to be set conform to each other, an assembly definition setting unit 3 for setting, when it is determined by the determination unit 2 that the attribute information in the CAD data and the attribute information in the assembly definition data conform to each other, the degrees of freedom in the assembly definition of the component on the basis of the data defining the degrees of freedom in the assembly definition data.

According to the present invention, the degrees of freedom in the assembly definition of a component can be set independently of the level of expertise of the operator. Accordingly, it is possible to reduce setting errors of the degrees of freedom made by the operator and to improve the accuracy of setting the assembly definition.

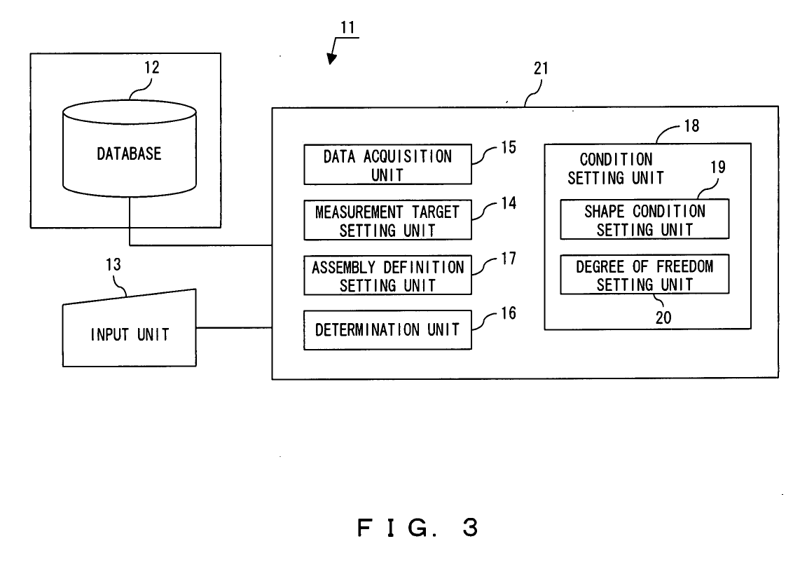

FIG. 3 is a block diagram of a CAD (Computer-Aided Design) device 11 in the embodiment of the present invention.

In an assembly definition database 12 of the CAD device 11, a plurality of assembly definition data are registered in advance, each of which includes data expressing a name of assembly definition, a definition order, a shape of the definition part, the degrees of freedom and the like. This assembly definition data is used for facilitating setting of the assembly definition of a component by an operator. In addition to the above members, the CAD device 11 comprises a design database in which CAD data which is design data of a component is registered. An input unit 13 is an input device used by an operator to input the design data and the like.

A measurement target setting unit 14 sets, when an operator selects a particular assembly definition data and specifies a set-up part in a component via the input unit 13, the selected/specified data as a measurement target.

A data acquisition unit 15 acquires the selected assembly definition data from the assembly definition database 12 and also acquires shape data of a specified part in a component from the design database.

A determination unit 16 sequentially compares the attribute information (shape data, for example) specified by the definition order in the selected assembly definition data with the attribute information of the specified set-up part, and determines whether or not they conform to each other.

An assembly definition setting unit 17 sets the degrees of freedom in the selected assembly definition data as the degrees of freedom of the specified part when it is determined that the attribute information in the assembly definition data and the attribute information of the specified part conform to each other.

The CAD device 11 according to the present embodiment has a function by which an operator can arbitrarily register assembly definition data of a component in addition to the function of setting the assembly definition of a component by using the assembly definition data registered in the assembly definition database 12 in advance. A condition setting unit (corresponding to a register unit) 18 provides this register function of the assembly data. A shape condition setting unit 19 provides a function of setting a shape or the like of a component about which the assembly definition is to be set. The degrees of freedom setting unit 20 provides a function of a set-up definition part of a component and of setting the degrees of freedom of the definition part.

The above measurement target setting unit 14, data acquisition unit 15, determination unit 16, assembly definition setting unit 17 and condition setting unit 18 correspond to an assembly definition setting program (or a tolerance analysis program) 21.

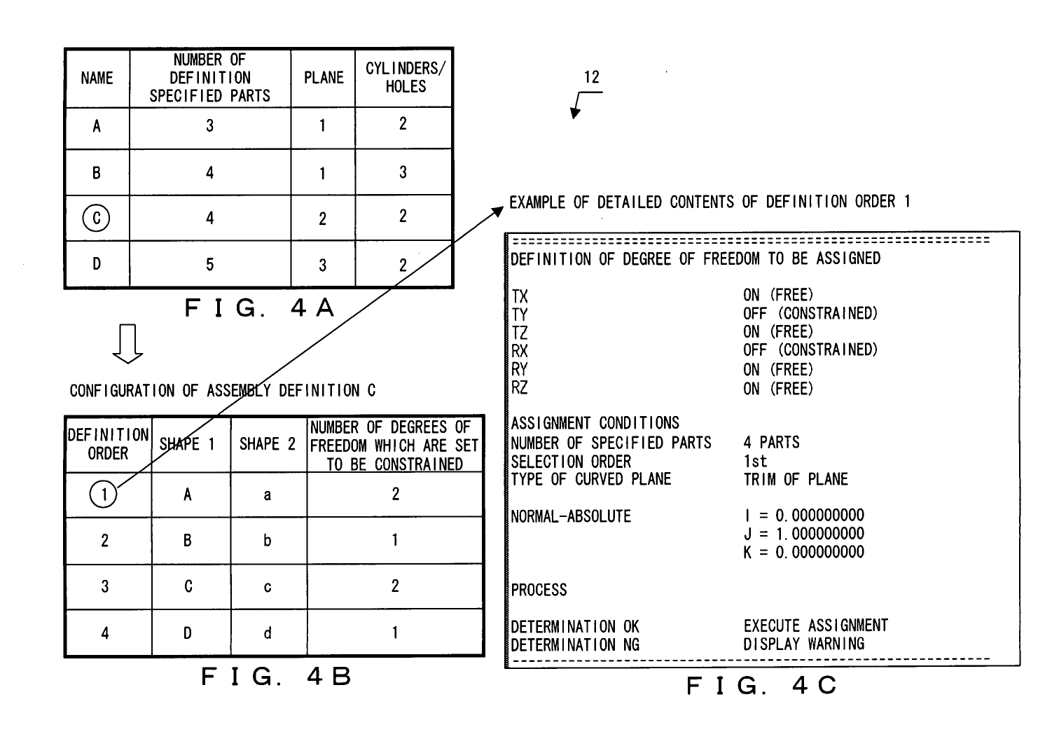

FIG. 4 show an example of a configuration of the assembly definition data in the assembly definition database 12.

FIG. 4A shows a data configuration of a upper layer in the assembly definition data. FIG. 4B shows a data configuration of a layer immediately below the layer of FIG. 4A. FIG. 4C shows a detailed data configuration of the definition order 1 of FIG. 4B.

The data shown in FIG. 4A comprises a name of assembly definition, the number of definition specified parts, the number of planes and the number of cylinders or of holes. The number of definition specified parts is information expressing the number of set-up definition parts of a component. The number of planes and the number of cylinders/holes are respectively information expressing the number of the planes of the definition specified parts and information expressing the number of the cylinders/holes.

FIG. 4B shows a configuration of an assembly definition C. The assembly definition data comprises information (number, for example) expressing the definition order of the assembly definition, shape information of one component and shape information of the other component at the definition part, and the number of degrees of freedom which are set to be constrained.

The degrees of freedom are for defining how dimensional and angular errors in each component influence dimensional and angular errors of an entire product which is made by assembling the components.

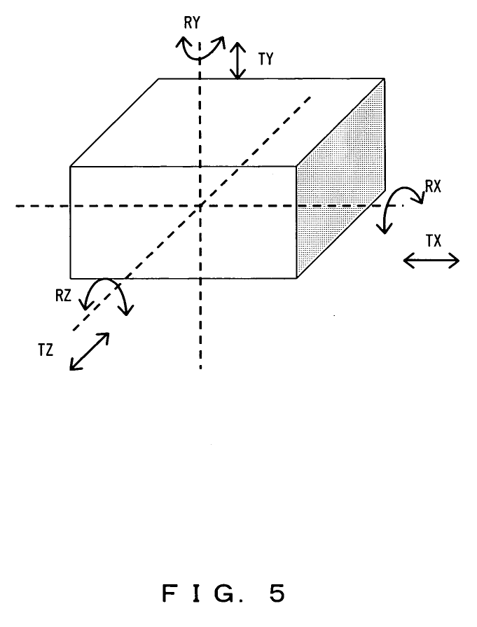

In the present embodiment, as shown in FIG. 5, for each component, six degrees of freedom are defined, including degrees of freedom TX, TY and TZ in the directions of the X, Y and Z axes, and degrees of freedom of rotation RX, RY and RZ about the X, Y and Z axes. When a particular axial or angular direction of a component influences errors of the entire product made by assembling the components, the degree of freedom is set to “Constrained”, and when it does not influence errors the degree of freedom is set to “Free”.

The number of the constrained degrees of freedom of FIG. 4B expresses the number of the degrees of freedom which is set to be “Constrained” as the definition of the degree of freedom. In the data of the definition order 1, the number of the degrees of freedom that is “Constrained” is “2”, and the other degrees of freedom are set to be “Free”. In the data of the definition order 2, the number that is “Constrained” is “1”, and the other degrees of freedom are set to be “Free”. It is described in detailed information of data of each definition order, which of the degrees of freedom are set to be “Constrained” for a plurality of the degrees of freedom.

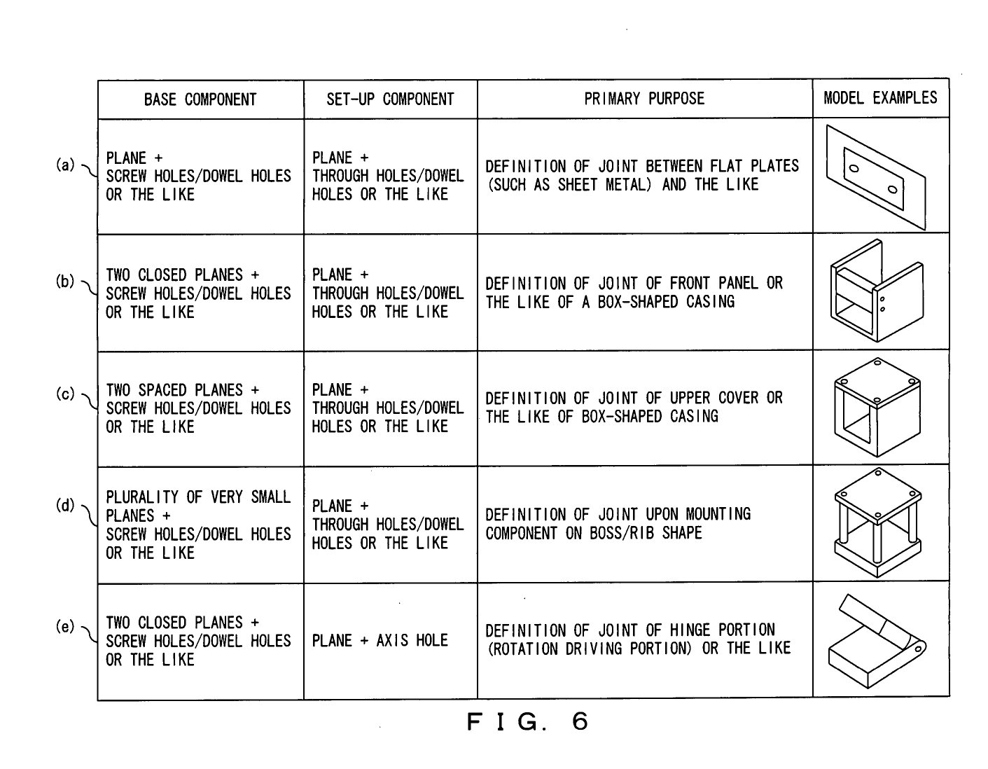

FIG. 4C shows the detailed contents of the data of the definition order 1. The assembly definition C relates to an assembly definition for a configuration in which an upper cover is attached to upper portions of a U-shaped component including opposing left and right planes and a bottom plane (referred to as box-shape hereinafter) as shown in FIG. 6 (c) for example.

The data of the definition order 1 defines a connection between the left plane of the box-shaped component, having two planes in vertical directions, and a left-lower portion of the upper cover.

In the data of the definition order 1, the degrees of freedom TX and TZ in the directions of the X and Z axes are set to “Free”, and the degrees of freedom TY in the direction of the Y axis is set to “Constrained”. With regards to rotation, the degrees of freedom of the rotation RY and RZ about the Y and Z axes are set to be “Free”, and the degree of freedom of the rotation RX about the X axis is set to be “Constrained”. Additionally, in FIG. 4C, “Trim on a plane” is defined as a “Type of plane”, and this means that the definition part is a plane. Additionally, “I=0.00 . . . , J=1.00 . . . , and K=0.00 . . . ” are defined as a “Normal-Absolute”, and this means that the direction of the normal of the plane is “J=1”, i.e., the direction of the normal includes a component in the direction of the Y axis.

FIG. 6 shows an example of displaying the assembly definitions in the CAD device 11.

The case (a) of FIG. 6 shows an example of displaying the assembly definition for a configuration between planes. In this case, a base component consists of a plane, screw holes or dowel holes (holes for connecting two components) or the like, and a component to be attached to the base component consists of a plane, through holes/dowel holes or the like. This assembly definition is employed when two flat plates such as sheet metals or the like are connected to each other by screws or the like.

The case (b) of FIG. 6 shows an example of displaying the assembly definition for a configuration in which a component is set up between left and right planes. In this case, the base component consists of two planes which are parallel (two planes which are closed), screw holes or dowel holes or the like. The component to be attached to the base component consists of a plane, through holes/dowel holes or the like. This assembly definition is employed when a front panel or the like is fixed to a box-shaped casing.

The case (c) of FIG. 6 shows an example of displaying the assembly definition for a configuration in which a component is set up to upper portions of two planes which are parallel and spaced apart from each other. In this case, the base component consists of two planes which are parallel and spaced apart from each other, and screw holes/dowel holes or the like. The component to be attached to the base component consists of a plane, and through holes/dowel holes or the like. This assembly definition is employed when an upper cover or the like is fixed to a box-shaped casing.

The case (d) of FIG. 6 shows an example of displaying the assembly definition for a configuration in which a component is set up on a rib. In this case, the base component consists of a plurality of pole shaped very small planes, and screw holes/dowel holes or the like. The component which is to be attached to the base component consists of a plane, and through holes/dowel holes or the like. This assembly definition is employed when a component is fixed to an upper portion of a component in a shape of a boss/rib.

The case (e) of FIG. 6 shows an example of displaying the assembly definition for a configuration in which two components are connected by a hinge or the like. In this case, the base component consists of an axis hole and two planes which are closed and which are for supporting another component. The component to be connected to the base component consists of a plane and an axis hole. This assembly definition is employed when a hinge portions (rotation driving portions) or the like are connected.

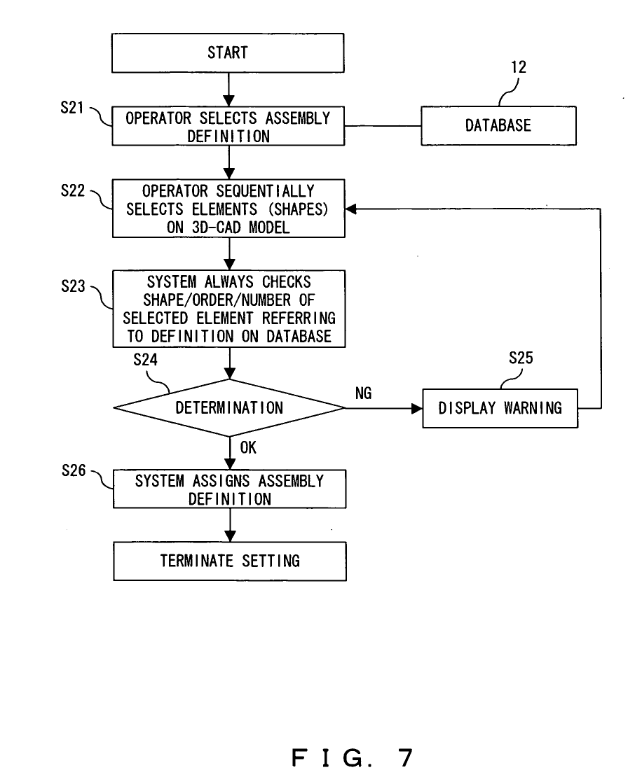

Next, an assembly definition setting process of the CAD device 11 according to an embodiment will be explained by referring to the flowchart of FIG. 7. The processes below are executed by a CPU of the CAD device 11. Additionally, in FIG. 7, instructions made by an operator are also described.

The operator selects assembly definition data conforming to the shape of a component whose assembly definition is to be set, from a plurality of assembly data displayed on a display device (S21 of FIG. 7). When a particular assembly definition is selected, the selected assembly definition data is read from the assembly definition database 12.

Next, the operator sequentially specifies the set-up parts (elements) of components displayed on the display device (S22).

The shape data of the definition part, the number of definition parts and the like are read from the assembly definition database 12 in accordance with the definition order in the assembly definition data, and the above data is compared with the specified set-up parts of components and with the number of the specified parts, and then, it is determined whether or not the data matches these factors (S23).

When the shape data of the specified set-up part or the number of the specified parts does not match the corresponding data in the assembly definition data (NG in S24), the process proceeds to a step S25 and displays a warning indicating that the contents specified by the operator are not appropriate.

When it is determined that the shape data of the specified set-up part and the number of the specified parts match the shape data of the definition part and the number of the definition specified parts specified by the definition order in the assembly definition data in a step S24 (OK in step S24), the process proceeds to a step S26, and the degrees of freedom defined in the assembly definition data is set as the degrees of freedom of the specified set-up part.

In the above process, for example, the degrees of freedom in the direction of the axis at the specified part and the degrees of freedom of the rotation about the axis are set on the basis of the degrees of freedom in the assembly definition data.

When the setting of the assembly definition of a component is completed, the cumulative value of the dimensional tolerance and the angular tolerance of the component is calculated on the basis of the set assembly definition. Then, the cumulative value of the tolerance obtained by the calculation is analyzed in order to determine whether it satisfies the tolerance required by the product (analysis unit). Thereby, it is possible to accurately analyze whether or not the dimensions of the product made by assembling the components satisfy the tolerance required by the product.

In the above embodiment, when the assembly definition of a component designed by the CAD device 11 is to be set, a plurality of assembly definition data registered in the assembly definition database 12 in advance or the assembly models of the component defined by the assembly definition are displayed on the display device, then the operator selects the assembly definition data which includes a shape similar to that of the component of which the assembly definition is to be set. When the operator specifies the set-up part of the component after selecting a particular assembly definition data, the assembly definition program of the CAD device 11 determines whether or not the shape information, the number of the specified parts and the like of the specified set-up part match the shapes and the like specified by the definition order in the assembly definition data.

When it is determined that the shape information of the specified part does not match the shape information specified by the definition order in the assembly definition data, a warning message is displayed. The operator recognizes that the specified contents include an error by seeing the warning message such that the operator can immediately correct the specified contents. Thereby, the setting and the correction of the assembly definition of a component can be conducted efficiently.

When it is determined that the shape information of the specified part and the shape information in the assembly definition data match, the data expressing the degrees of freedom of the component corresponding to the definition order in the assembly definition data is automatically set as the degrees of freedom of the specified part of the component. Thereby, the setting of the assembly definition of a component by an operator is facilitated, and also it is possible to set an assembly definition of a constant quality independently of the level of expertise of the operator.

Further, the setting errors of the degrees of freedom of a component in the assembly definition by an operator can be reduced such that the accumulated tolerance of a product made by assembling the components can be calculated accurately. Thereby, it is possible to accurately analyze whether or not the accumulated tolerance satisfies the dimensional tolerance or the angular tolerance required by the product in a design phase.

Further, it is possible to accurately analyze whether or not the accumulated tolerance satisfies the dimensional tolerance or the angular tolerance required by the product before the components are assembled into the product. Accordingly, it is possible to avoid an inefficient outcome or the like in which it is found that the dimensional tolerance of a product does not satisfy the specification of the product after the product is made by assembling components, and the design has to be reviewed again as in conventional methods.

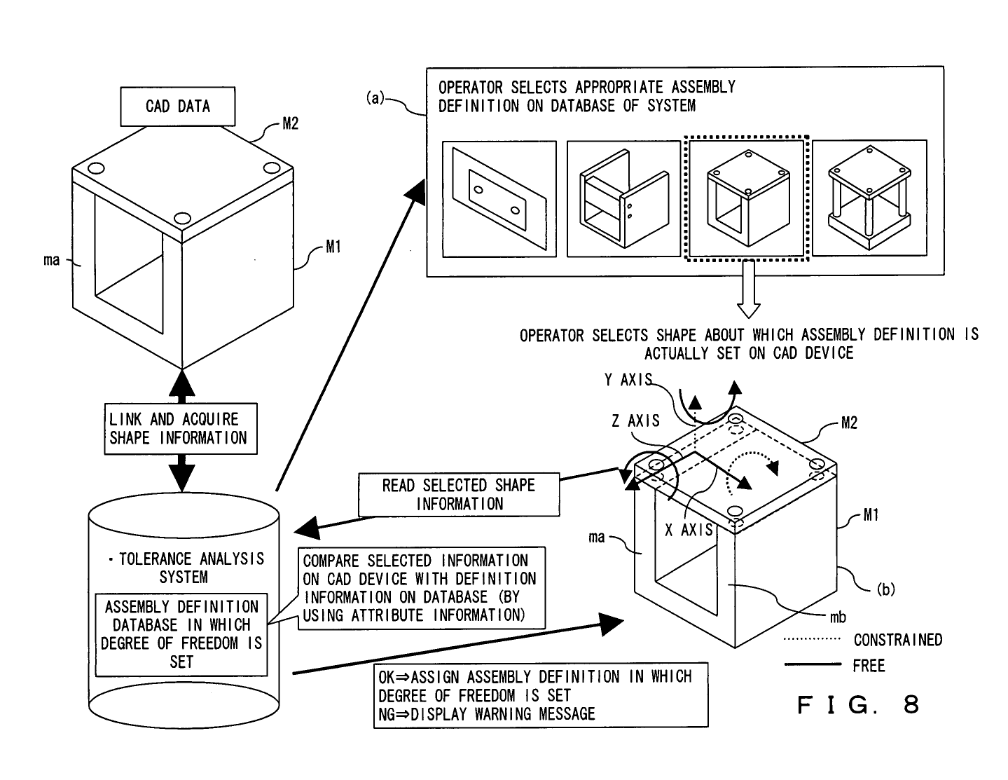

FIG. 8 explains a method of setting an assembly definition for a configuration in which a component M2 as an upper cover is to be screwed to an upper portion of a component M1 in a box shape.

The table (a) of FIG. 8 shows assembly models of assembly definition data displayed on the display device of the CAD device 11. In a definition order 1 (which will be explained later) in the assembly definition of a box-shaped component shown in the table (a) of FIG. 8, with regards to the degrees of freedom in the axial directions of the component, the degrees of freedom in the directions of the X and Z axes are set to be free, and the degree of freedom in the direction of the Y axis is set to be constrained. Regarding the degrees of freedom in the rotational directions, the degrees of freedom of the rotation about the Z and Y axes are set to be free, and the degree of freedom of the rotation about the X axis is set to be constrained. Here, the state in which the degrees of freedom in the axis direction or the degrees of freedom in the rotational direction is set to be free, is a state in which dimensional variations or angular variations of a particular axis direction do not cause dimensional or angular influence of a product made by assembling components. The state in which the degrees of freedom is set to be constrained is a state in which dimensional variation or angular variation of components cause a dimensional or an angular influence of a product made by assembling the components.

The view (b) of FIG. 8 shows the contents of the degrees of freedom of the specified part which is set based on the selected assembly definition data when the operator specifies the upper surface of the left plane of the box-shaped component M1 and the left lower surface of the component M2 as the assembly definition part.

When the operator specifies a component about which the assembly definition is to be set, a tolerance analysis system (the assembly definition setting program) of the CAD device 11 acquires the CAD data including shape information of the selected component.

When the assembly definition of a component is set, a plurality of assembly definition data which can be selected or models which are 3D images of the assembly definition data are displayed on a display unit. The operator selects the assembly definition data similar to an assembled shape of the component. Upon this, 3D images such as a model of connecting two flat plates, a model of connecting a front panel to a box-shaped casing, a model of connecting an upper cover to a box-shaped casing, a model of connecting an upper cover on four poles or the like is displayed on the display device.

The operator specifies the set-up part of the component in the 3D images displayed on the display unit. The tolerance analysis system compares the shape information of the part specified by the operator with the shape information specified by the definition order in the selected assembly data, and determines whether or not they match each other.

When the above two factors do not match each other, a warning message for indicating that the specified part is not appropriate is displayed. When they match each other, the degrees of freedom in the assembly definition data is set as the degrees of freedom of the specified part of the component.

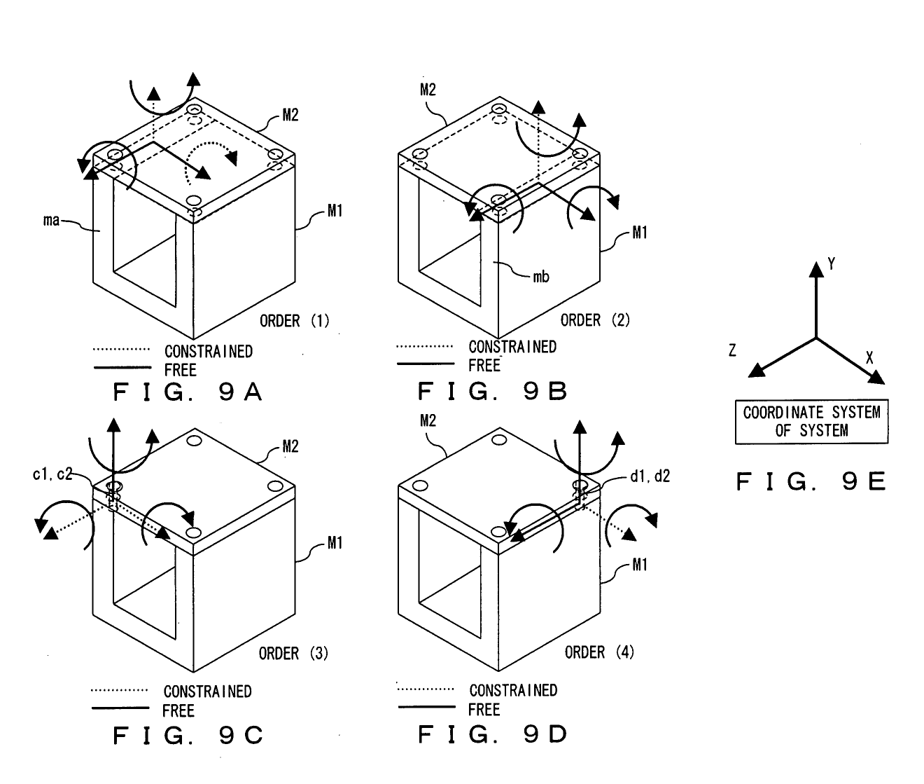

FIGS. 9A to 9E explain the four definition orders in the assembly definition in the case where the above component M1 is a box-shape (U-shaped) and the component M2 as the upper cover are fixed to each other at the lateral corners of the components with two screws. FIG. 9E shows directions of coordinate axes of the CAD data.

As described above, as the assembly definition data (see FIG. 4) registered in the assembly definition database 12, the shape data, the degrees of freedom and the like are registered with the definition order, and the shape information of the definition specified part, expressing which part of the component the assembly definition is made on, data expressing whether the degrees of freedom are “Free” or “Constrained” and the number of the degrees of freedom which are set to be constrained, in an associated state with the definition order information expressing the definition order of the component.

FIG. 9A explains the definition order 1. In the assembly definition database 12 of FIGS. 4A to 4C, the upper surface of a left plane ma of the component M1 and a lower surface of the component M2 are registered as the definition specified part with the definition order 1 of the box-shaped component M1 and the component M2 as its upper cover shown in FIG. 9A.

As for the degrees of freedom of the component with the definition order 1 in the directions of coordinate axes, data expressing that the degrees of freedom TX and TZ in the directions of X and Z axes indicated by arrows with full lines are set to be free, and data expressing that the degrees of freedom YT in the direction of the Y axis indicated by an arrow with a dotted line is set to be constrained are registered. Further, as for the degrees of freedom in the directions of rotations about the coordinate axes, the degrees of freedom RY and RZ in the directions of the rotations about the Y and Z axes indicated by arrows with full lines are set to be free, and data expressing that the degree of freedom RX in the direction of the rotation about the X axis indicated by an arrow with a dotted line is set to be constrained are registered respectively. The degrees of freedom TX, TY and TZ in the directions of axes and the degrees of freedom RX, RY and RZ in the directions of the rotations are identical to the degrees of freedom TX, TY, TZ, RX, RY and RZ of FIG. 4C.

FIG. 9B explains the assembly definition 2. In the assembly definition database 12, the upper surface of a right plane mb of the component M1 and a lower surface of the component M2 are registered as the definition specified part at the definition order 2 of the box-shaped component M1 and the component M2 as its upper cover.

As for the degrees of freedom of the component at the definition order 2 in the directions of coordinate axes, data expressing that degrees of freedom TX and TZ in the directions of X and Z axes indicated by arrows with full lines are set to be free, and data expressing that the degree of freedom YT in the direction of the Y axis indicated by an arrow with a dotted line is set to be constrained are registered. Further, as for the degrees of freedom in the directions of the rotations about the coordinate axes, the degrees of freedom RY and RZ in the directions of the rotations about the Y and Z axes indicated by arrows with full lines are set to be free, and data expressing that the degree of freedom RX in the direction of the rotation about the X axis is set to be constrained are registered.

FIG. 9C explains the assembly definition 3. In the assembly definition database 12, a joint hole c1 on the upper surface of the left plane ma of the component M1 and a joint hole c2 piercing a left and near corner among the four corners of the component M2 are registered as the definition specified part at the definition order 3 of the box-shaped component M1 and the component M2 as its upper cover.

As for the degrees of freedom of the component at the definition order 3 in the directions of coordinate axes, data expressing that the degrees of freedom TX and TZ in the directions of X and Z axes indicated by arrows with dotted lines are set to be constrained, and data expressing that the degree of freedom YT in the direction of the Y axis is set to be free are registered. Further, as for the degrees of freedom of the rotations about the coordinate axes, all the degrees of freedom RX, RY and RZ in the directions of the rotations about the X, Y and Z axes are set to be free.

FIG. 9D explains the assembly definition 4. In the assembly definition database 12, a joint hole d1 on the upper surface of the right plane mb of the component M1 and a joint hole d2 piercing a right and far corner among the four corners of the component M2 are registered as the definition specified part at the definition order 4 of the box-shaped component M1 and the component M2 as its upper cover.

As for the degrees of freedom of the component at the definition order 4 in the directions of coordinate axes, data expressing that the degrees of freedom in the directions of Y and Z axes indicated by arrows with full lines are set to be free, and data expressing that the degrees of freedom in the direction of the X axis is set to be constrained are registered. Further, as for the degrees of freedom in the directions of the rotations about the coordinate axes, all the degrees of freedom in the directions of the rotations about the X, Y and Z axes are set to be free are registered.

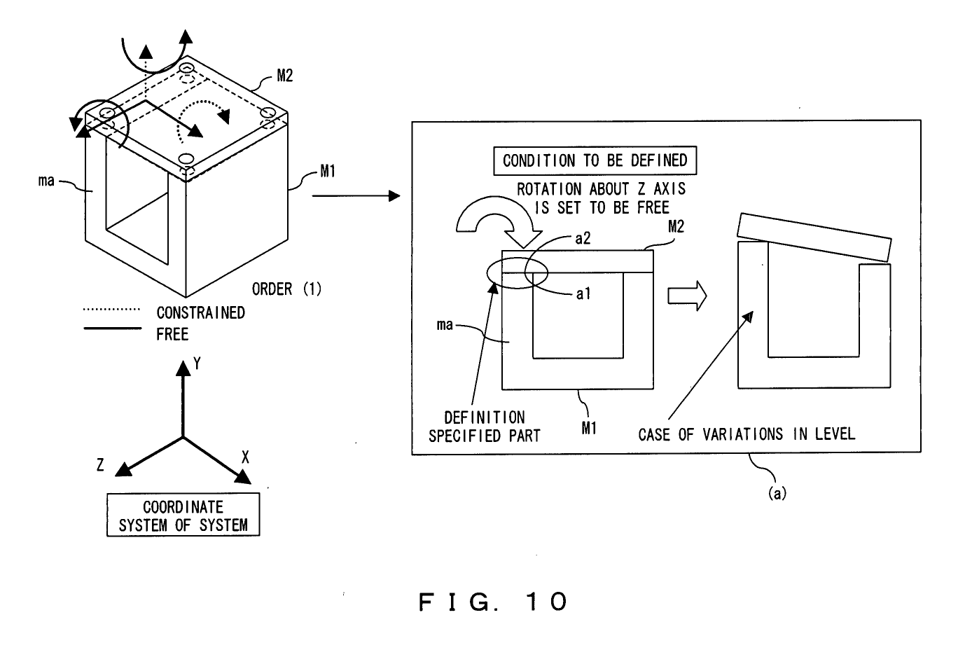

FIG. 10 explains a method of setting the degrees of freedom in the data at the definition order 1 of the above box-shaped component M1 and component M2 used as the upper cover of the component M1.

The definition parts at this definition order 1 are an upper surface a1 of the left plane ma of the component M1 and a lower surface a2 of the component M2, and planes a1 and a2 on which they contact each other are on the X-Z plane. Accordingly, the dimensional variations in the directions of X or Z axes of the component M1 do not influence the dimension in the direction of the X axis or in the direction of the Z axis of the product made by assembling the component M1 and the component M2. Regarding the direction of the Y axis, the variation in the direction of the Y axis of the component M1 influences the dimensions in the direction of the Y axis of the product made by assembling the component M1 and the component M2.

As shown in a view (a) of FIG. 10, when the level of the component M1 becomes higher in the direction of Y axis, the level of the component M2 on the component M1 also becomes higher. Accordingly, it can be defined that the degrees of freedom of the component M1 and the component M2 are constrained in the direction of the Y axis based on the assembly definition 1 i.e., it can be defined that the dimensional error in the direction of the Y axis influences the product.

Also, the upper surface of the component M1 and the set-up surface of the component M2 have a sufficient length in the direction of the Z axis such that the rotation of the component M1 and the component M2 about the X axis is restricted by the set-up surfaces a1 and a2 extending in the direction of the Z axis. Accordingly, it can be defined that the degrees of freedom of the component M1 and the component M2 are constrained in the direction of the rotation about the X axis i.e., it can be defined that the error of the rotation about the X axis influences the component M1 and the component M2.

Based on the above assembly definition data at the definition order 1, it can be defined that the degree of freedom in the direction of the Y axis is constrained, and that the degree of freedom of the rotation about the X axis is constrained.

The assembly definition setting program 21 of the CAD device 11 compares the shape data of the part originally specified by the operator with the shape data of the definition specified part in the data at the definition order 1, and determines whether or not the above shape data match each other.

When a plane which is not perpendicular to the direction of the Y axis or a shape which is not a plane is specified as the part to be specified first, the assembly definition setting program determines that the specified contents are not correct and displays a warning message.

When a plane which is perpendicular to the direction of the Y axis (a plane parallel to the plane X-Z) is specified, the assembly definition setting program 21 determines that the above shape data match each other, and sets the degrees of freedom defined in the data at the definition order 1 as the degrees of freedom of the part specified first in the component. As a result of this, as the degrees of freedom in the assembly definition of the part specified first, the degree of freedom TY in the direction of the Y axis and the degree of freedom RX of the rotation about the X axis are set to be “Constrained” and the other degrees of freedom are set to be “Free”.

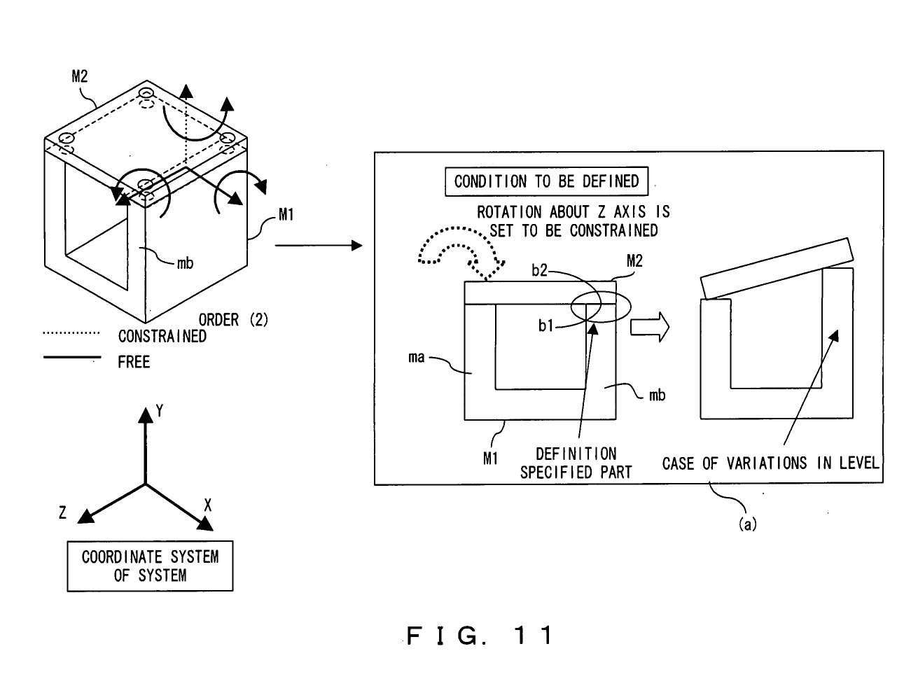

FIG. 11 explains a method of setting the degrees of freedom in the data at the definition order 2 of the box-shaped component M1 and the component M2 used as the upper cover of the component M1.

The specified parts in the data at the definition order 2 are an upper surface b1 of the right plane mb of the component M1 and a lower surface b2 of the component M2. The planes b1 and b2 on which they contact each other are on the X-Z plane, accordingly, the dimensional variation in the direction of the X axis or of the Z axis does not influence the dimensions of the directions of the X axis or of the Y axis of the product made by assembling the components M1 and M2. As for the direction of the Y axis, the dimensional variation in the direction of the Y axis of the component M1 influences the dimensions in the direction of the Y axis of the product made by assembling the components M1 and M2.

As shown in a view (a) of FIG. 11, when a level of the right plane mb of the component M1 becomes higher in the direction of the Y axis, the level of the component M2 on the component M1 also becomes higher in the direction of the Y axis. Accordingly, based on this definition order 2, the degree of freedom in the direction of the Y axis is constrained. By setting the degree of freedom in the direction of the Y axis in the assembly definition data to “Constrained”, it is possible to define that the dimensional error in the direction of the Y axis of the component M1 influences the dimensions of the product made by assembling the components M1 and M2.

It is possible to substantially “Constrain” the degree of freedom RZ of the rotation about the Z axis by setting the degree of freedom TY in the direction of the Y axis of the left plane ma of the component M1 in the data at the definition order 1 and by setting the degree of freedom TY in the direction of the Y axis of the right plane mb of the component M1 in the data at the definition order 2. Accordingly, it is possible to define that the degree of freedom RZ of the rotation about the Z axis is “Constrained” based on the data at the definition order 1 and the data at the definition order 2.

When the operator specifies the second part, the assembly definition setting program 21 compares the shape data of the second specified part with the shape data of the definition specified part in the data at the definition order 2, and determines whether or not they match each other.

When a plane which is not parallel to the surface defined in the data at the definition order 1 is specified as the second specified part or when a part of a shape which is not a plane is specified, the assembly definition setting program 21 determines that the specified contents are not correct, and displays a warning message.

When the second specified part is a plane which is parallel to the plane defined in the data at the definition order 1, the degrees of freedom of the second specified part of the component is set in accordance at the degrees of freedom defined in the data at the definition order 2. In this case, based on the setting of degrees of freedom in the data at the definition order 1 and the data at the definition order 2, the degree of freedom RZ of the rotation about the Z axis is substantially “Constrained”.

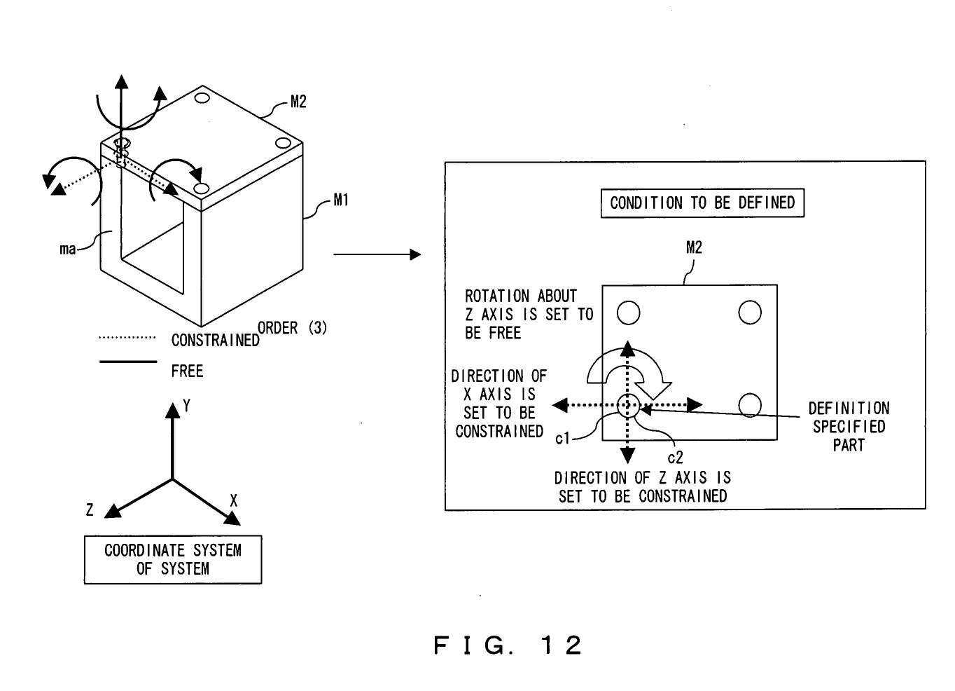

FIG. 12 explains the degrees of freedom in the data at the definition order 3 of the component M1 and the component M2.

The definition specified parts in the data at the definition order 3 are a joint hole c1 (hole or virtual datum axis) on the upper surface of the left plane ma of the component M1 and a joint hole c2 piercing a left and near corner of the component M2. By defining the joint holes c1 and c2 as the specified parts, the degree of freedom TX in the direction of the X axis and the degree of freedom TZ in the direction of the Z axis of the components M1 and M2 are constrained. Because by specifying one joint hole only, it is not possible to constrain the rotation about the Z axis, in this case, the degree of freedom RZ of the rotation about the Z axis is “Free”.

It is possible to define that the degree of freedom TX in the direction of the X axis and the degree of freedom TZ in the direction of the Z axis are “Constrained” based on the above assembly definition data at the definition order 3.

When the operator specifies the third set-up part, the assembly definition setting program 21 compares the shape data of the specified part and the shape data of the definition specified part in the data at the definition order 3 and determines whether or not they match each other.

When a hole or a datum axis which is not on the surface defined in the data at the definition order 1 is specified as the third specified part, the assembly definition setting program 21 determines that the specified contents are not correct, and displays a warning message.

When the third specified part is a hole or a datum axis which is on the plane defined in the data at the definition order 1 and which is perpendicular to the plane, it is determined that the specified contents are appropriate, and the degrees of freedom defined as the definition order 3 is set as the degrees of the freedom of the third specified part of the component. As the result of this, the degree of freedom TX in the direction of the X axis and the degree of freedom TZ in the direction of the Z axis are set to be “Constrained” and the other degrees of freedom are set to be “Free”.

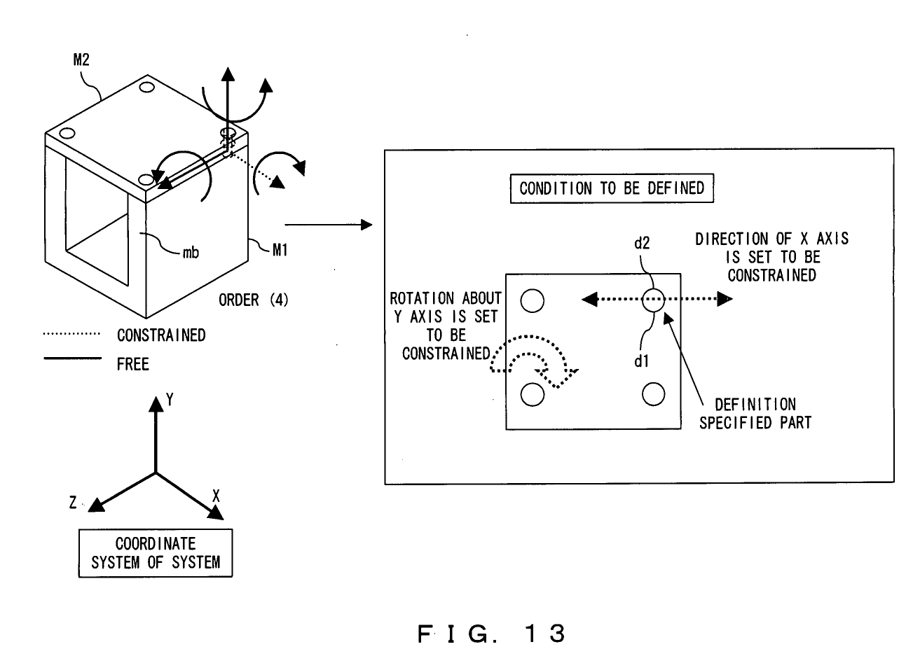

FIG. 13 explains the degrees of freedom in the data at the definition order 4 of the components M1 and M2.

The specified parts in the data at the definition order 4 are the joint hole d1 on the upper surface of the right plane mb of the component M1 and the joint hole d2 piercing the right and far corner of the component M2. By specifying the joint hole d1 of the component M1 and the joint hole d2 of the component M2, the degree of freedom TX in the direction of the X axis is constrained.

By defining the joint holes c1 and c2 on the left and near portions of the components M1 and M2 in the data at the definition order 3 and defining the joint holes d1 and d2 on the right and far portions which are across the above portions in the data at the definition order 4, the rotation about the Y axis of the components M1 and M2 are restricted. In other words, by the data at the definition order 3 and the data at the definition order 4, it is possible to substantially constrain the degree of freedom of the rotation RY about the Y axis of the components M1 and M2.

When the operator specifies the fourth part, the assembly definition setting program 21 compares the shape data of the fourth specified part with the shape data in the definition specified part at the definition order 4, and determines whether or not they match each other.

When a hole or a datum axis which is not on the plane defined in the data at the definition order 1 is specified as the fourth specified part, or when the specified hole is on the same plane but is not the hole located at the position at which the center of the specified hole is the farthest from the center of the hole defined in the data at the definition order 3, the assembly definition setting program determines that the specified contents are not correct, and displays a warning message. Thereby, when the holes which are not located at the positions of the across corners are specified, the warning message is displayed.

When the hole or the datum axis which is on the plane defined in the data at the definition order 1, which is perpendicular to the plane, and which is the hole or the datum axis whose center is the farthest from the center of the hole defined in the data at the definition order 3 is specified as the fourth specified part, it is determined that the specified contents are appropriate, and the degrees of freedom of the fourth specified part of the component is set based on the degrees of freedom defined in the data at the definition order 4. In this case, the joint hole on the left and near corner is specified in the data at the definition order 3 and the joint hole at the position which is the corner across from the above joint hole is specified in the data at the definition order 4, thereby, it is possible to substantially constrain the degree of freedom RY of the rotation about the Y axis.

As above, the assembly definition setting program 21 of the CAD device 11 can set the degrees of freedom in the six directions i.e., the directions of the X, Y and Z axes and of the rotations about the X, Y and Z axes based on the degrees of freedom at the definition orders 1 to 4 in the assembly definition data.

In the above embodiments, data expressing the shape data, the coordinate axes and the degrees of freedom of the rotations about the coordinate axes are, in advance, registered in the assembly definition database 12 in an associated state with the information expressing the definition orders 1 to 4, as the assembly definition data of the box-shaped component M1 and the component M2 as the upper cover or the like for example. And, when the operator specifies the part about which the assembly definition is to be set, it is determined whether or not the shape data of the component on the specified part matches the shape data of the definition specified part specified by the definition order, thereby, it is possible to determine whether or not the part of the component specified by the operator is correct. When it is determined that the above specified part is correct, it is possible to automatically set the degrees of freedom in the assembly definition registered in the assembly definition database 12 as the degrees of freedom of the specified part of the component.

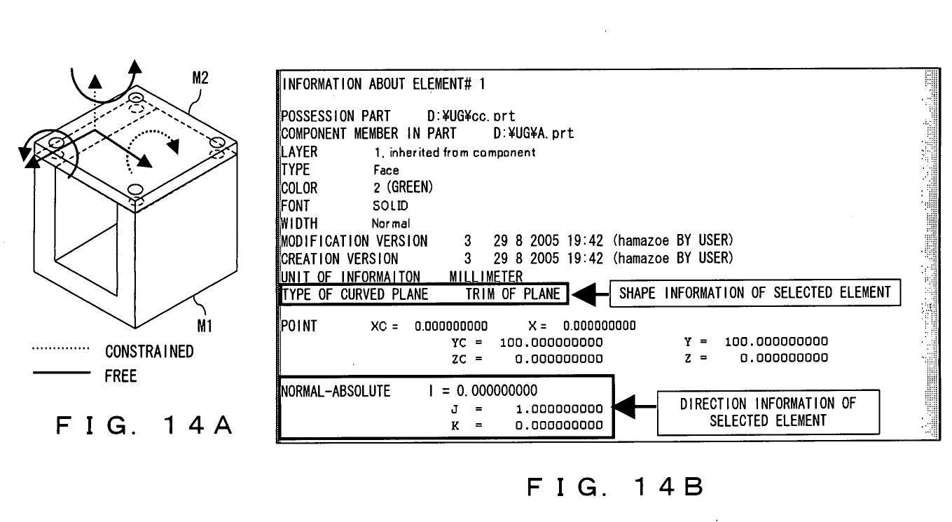

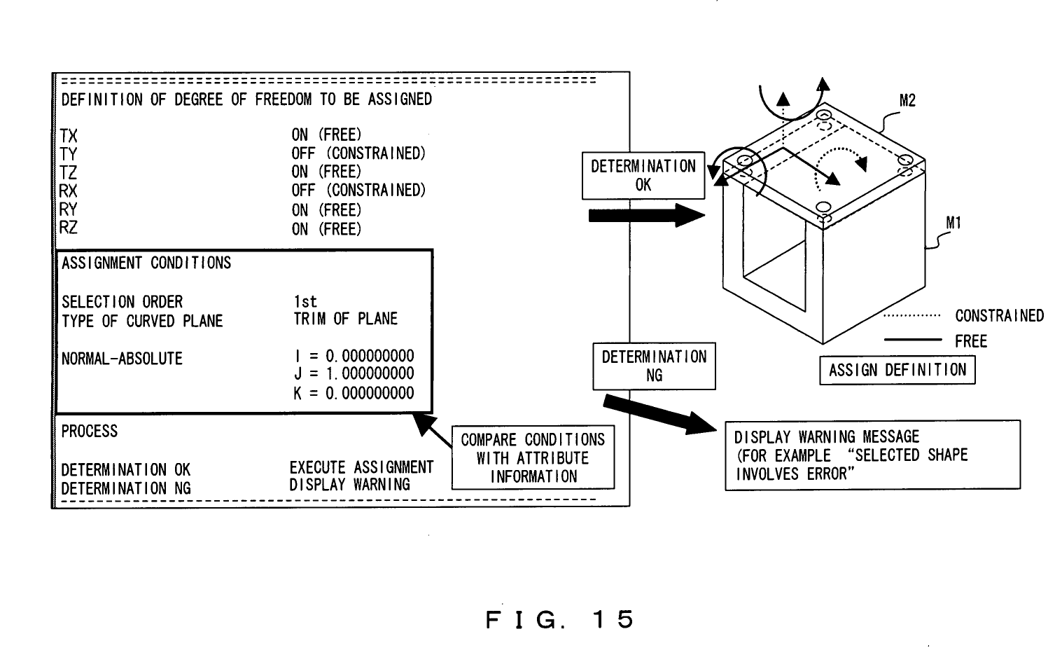

Next, the method will be explained in which it is determined whether or not the specified contents are appropriate by comparing the CAD data of the box-shaped component M1 and its upper cover component M2 shown in FIG. 14A and FIG. 14B with the assembly definition data in the data at the definition order 1 of FIG. 15.

When the operator specifies the upper surface of the left plane ma of the component M1 and the lower surface of the left portion of the component M2 are specified as the parts about which the assembly definition is to be set, the shape data of the specified part of the component is read from the CAD data shown in FIG. 14B. Specifically, the information specifying that the “Type of curved plane” of the surface selected by the operator is “Trim of plane (plane)” is acquired by the tolerance analysis system.

Direction information of the selected element shown in FIG. 14B is information about the direction of the set-up part specified by the operator, and “I” is in the direction of X axis, “J” is in the direction of the Y axis and “K” is in the direction of the Z axis. Because the specified type of curved plane is “plane”, the value of the normal in the direction of “J” is “1” and the values in the directions of “I” and “K”, are “0”, it can be recognized that the specified part is a plane which is perpendicular to the Y axis.

In the assembly definition data at the definition order 1 of the box-shaped component M1 and the upper cover component M2, the selection order (definition order) is 1, the type curve is “plane”, the value of the normal in the direction of “J” is “1”, and the values in the directions of “I” and “K” are “0”.

The attribute information (whether the selected part is a plane or a hole, the direction of the plane or the like) of the CAD data of the first set-up part specified by the operator is compared with the attribute information in the assembly definition data at the definition order 1, and when they match each other, the degrees of freedom of the specified set-up part is set based on the definition of the degrees of freedom in the assembly definition data. Specifically, as shown in FIG. 15, the degrees of freedom TX and TZ in the directions of X and Z axes are set to be “Free”, and the degree of freedom TY in the direction of the Y axis is set to be “Constrained”. Further, the degrees of freedom RY and RZ of the rotations about the Y and Z axes are set to be “Free”, and the degree of freedom RX of the rotation about the X axis is set to be “Constrained”. Thereby, when the operator specifies the set-up part of the component, the degrees of freedom which are appropriate for the specified part is automatically set.

When the attribute information of the CAD data of the part specified by the operator does not match the attribute information in the corresponding assembly definition data, the determination result is NG, and a warning message of “Selected shape involves an error” or the like is displayed.

In the above embodiment, it is determined whether or not the specification order in the assembly definition order matches the definition order in the assembly definition data. However, when it is not necessary to specify the definition order upon the setting the degrees of freedom in the assembly definition, the determination can be conducted without taking the definition order into consideration.

Additionally, the method of the attribute information of the assembly definition data is not limited to the information by the method in which it is defined by the information (I, J and K) expressing the direction of the normal of the set-up specified part, but can be the information expressing which surface the specified part of the component is on.

According to the above embodiments, the degrees of freedom of a component in the assembly definition can be set independently of a level of expertise of an operator. Accordingly, it is possible to reduce setting errors of the degrees of freedom made by an operator. Thereby, it is possible to analyze the tolerance of a product made by assembling a plurality of components more accurately.

What is claimed is:

1. A CAD device, comprising:
an assembly definition database in which a plurality of assembly definition data including attribute information of a set-up definition part of a component and data defining degrees of freedom of a component is registered;
a determination unit determining, when particular assembly definition data registered in the assembly definition database is selected and a set-up part of a component about which an assembly definition is to be set is specified, whether or not the attribute information in the selected assembly definition data and attribute information in the CAD data of the specified part of the component conform to each other; and
an assembly definition setting unit setting the degrees of freedom in the assembly definition of the component based on the data defining the degrees of freedom in the assembly definition data when it is determined by the determination unit that the attribute information in the CAD data and the attribute information in the assembly definition data conform to each other.

2. The CAD device according to claim 1, comprising:
a tolerance analysis unit calculating an cumulative value of tolerances of respective components based on assembly definition for respective components set by the assembly definition setting unit, and for analyzing whether or not the calculated cumulative value of tolerances satisfies tolerance required by a product.

3. The CAD device according to claim 1, comprising:
a warning unit displaying warning information indicating that the specified set-up part of the component is not appropriate when it is determined by the determination unit that the attribute information in the assembly definition data and the attribute information in the CAD data do not conform to each other.

4. The CAD device according to claim 1, comprising:
a register unit registering the assembly definition data in the assembly definition database.

5. The CAD device according to claim 1, wherein:
the data defining a degree of freedom in the assembly definition data includes data defining degrees of freedom in directions of coordinate axes and a degree of freedom in directions of rotation about the coordinate axes in the CAD data.

6. The CAD device according to claim 1, wherein:
the assembly definition data includes data expressing a definition order of an assembly definition of the component, shape information of a set-up definition part and data defining degrees of freedom in directions of coordinate axes and degrees of freedom in directions of rotation about the coordinate axes; and
the determination unit determines whether or not the shape information of the definition part and the shape information in the CAD data of the specified part conform to each other based on the data expressing the definition order.

7. The CAD device according to claim 1, wherein:
the data defining a degree of freedom in the assembly definition data includes data expressing whether or not dimensional variations in the directions of X, Y or Z axis of the component influences dimensions of a product made by assembling the components and data expressing whether or not angular variations in directions of rotation about X, Y or Z axis of the component influences angles of a product made by assembling the components.

8. The CAD device according to claim 5, wherein:
the data defining degrees of freedom in the assembly definition data of a component is data expressing whether or not variations in dimensions or in angles of the component influences dimensions or angles of a product made by assembling the components.

9. A method of setting an assembly definition for a component manufactured by a CAD device, comprising:
determining, when particular assembly definition data is selected, which is in an assembly definition database in which a plurality of assembly definition data including attribute information of a set-up definition part of a component and data defining a degree of freedom of a component is registered and a set-up part of a component about which an assembly definition is to be set is specified, whether or not the attribute information in the selected assembly definition data and attribute information in the CAD data of the specified part of the component conform to each other; and
setting the degrees of freedom in the assembly definition of the component based on the data defining degrees of freedom in the assembly definition data when it is determined that the attribute information in the CAD data and the attribute information in the assembly definition data conform to each other.

10. The method of setting an assembly definition for a component manufactured by a CAD device according to claim 9, comprising:
calculating an cumulative value of tolerances of respective components based on assembly definition set for respective components; and
analyzing whether or not the calculated cumulative value of tolerances satisfies tolerance required by a product.

11. The method of setting an assembly definition for a component manufactured by a CAD device according to claim 10, comprising:
a warning unit displaying warning information indicating that the specified set-up part of the component is not appropriate when it is determined that the attribute information in the assembly definition data and the attribute information in the CAD data do not conform to each other.

12. The method of setting an assembly definition for a component manufactured by a CAD device according to claim 9, wherein:
the data defining degrees of freedom in the assembly definition data includes data defining degrees of freedom in directions of coordinate axes and degrees of freedom in directions of rotation about the coordinate axes in the CAD data.

13. The method of setting an assembly definition for a component manufactured by a CAD device according to claim 9, wherein:
the assembly definition data in the assembly definition database includes data expressing a definition order of a set-up definition part of the component, shape information of a set-up definition part and data defining degrees of freedom in directions of coordinate axes and degrees of freedom in directions of rotation about the coordinate axes; and
it is determined whether or not the shape information of the definition part and the shape information in the CAD data of the specified part conform to each other based on the data expressing the definition order.

14. The method of setting an assembly definition for a component manufactured by a CAD device according to claim 12, wherein:
the data defining a degree of freedom in the assembly definition data of a component is data expressing whether or not dimensional or angular variations of the component causes dimensional or angular influence of a product made by assembling the components.

15. The method of setting an assembly definition for a component manufactured by a CAD device according to claim 9, wherein:
the data defining degrees of freedom in the assembly definition data includes data expressing whether or not dimensional variations in the directions of X, Y or Z axis of the component influences dimensions of a product made by assembling the components and data expressing whether or not angular variations in directions of rotation about X, Y or Z axis of the component causes angular influence of a product made by assembling the components.

16. A storage medium storing a computer executable program for setting an assembly definition for a component, comprising:
a step of determining, when particular assembly definition data is selected, which is in an assembly definition database in which a plurality of assembly definition data including attribute information of a set-up definition part of a component and data defining a degree of freedom of a component is registered and a set-up part of a component about which an assembly definition is to be set is specified, whether or not the attribute information in the selected assembly definition data and attribute information in the CAD data of the specified part of the component conform to each other; and
a step of setting the degree of freedom in the assembly definition of the component based on the data defining degrees of freedom in the assembly definition data when it is determined that the attribute information in the CAD data and the attribute information in the assembly definition data conform to each other.

17. The storage medium storing a computer executable program for setting an assembly definition for a component according to claim 16, comprising:
a step of calculating an cumulative value of tolerances of respective components based on assembly definition set for respective components; and analyzing whether or not the calculated cumulative value of tolerances satisfies tolerance required by a product.

18. The storage medium storing a computer executable program for setting an assembly definition for a component according to claim 16, comprising:
a step of displaying warning information indicating that the specified set-up part of the component is not appropriate when it is determined in the determination step that the attribute information in the assembly definition data and the attribute information of the component do not conform to each other.

19. The storage medium storing a computer executable program for setting an assembly definition for a component according to claim 16, wherein:
the data defining degrees of freedom in the assembly definition data includes data defining degrees of freedom in directions of coordinate axes and degrees of freedom in directions of rotation about the coordinate axes in the CAD data.

20. The storage medium storing a computer executable program for setting an assembly definition for a component according to claim 16, wherein:
the assembly definition data in the assembly definition database includes data expressing a definition order of an assembly definition of a set-up definition part of the component, shape information of a set-up definition part and data defining degrees of freedom in directions of coordinate axes and degrees of freedom in directions of rotation about the coordinate axes; and
it is determined whether or not the shape information of the definition part and the shape information in the CAD data of the specified part conform to each other based on the data expressing the definition order.
